(19) United States
(12) Patent Application Publication
(10) Pub. No.: US 2016/0301090 A1
(43) Pub. Date: Oct. 13, 2016

(54) FUEL CELL SYSTEM AND CONTROL METHOD

(71) Applicant: BROTHER KOGYO KABUSHIKI KAISHA, Nagoya-shi (JP)

(72) Inventor: Yoshinori Mitsui, Kariya-shi (JP)

(21) Appl. No.: 15/188,637

(22) Filed: Jun. 21, 2016

Related U.S. Application Data
(63) Continuation of application No. PCT/JP2014/059147, filed on Mar. 28, 2014.

(30) Foreign Application Priority Data
Dec. 27, 2013 (JP) 2013-272349

(51) Int. Cl. H01M 8/04223; H01M 8/04664; H01M 8/04746; H01M 8/04992; H01M 8/0438

(52) U.S. Cl. CPC H01M 8/04231; H01M 8/04992; H01M 8/04388; H01M 8/04753; H01M 8/04671

(57) ABSTRACT

A fuel cell system is provided in which abnormality in the purge valve is allowed to be inspected without using fuel gas. A fuel cell system of the present disclosure includes a substitution passage member connected to a fuel gas passage member and to an oxidation gas passage member. A valve is connected in the middle of the substitution passage member. A control part opens the valve so as to form an inspection route passes through the oxidation gas passage member, the substitution passage member, and the fuel gas passage member. The control part inspects normality or abnormality in the opening and closing operation of a purge valve by using oxidation gas supplied from an air pump to the inspection route.

### CROSS-REFERENCE TO RELATED APPLICATIONS

The present application is a continuation application of International Application No. PCT/JP2014/059147, filed Mar. 28, 2014, which claims priority to Japanese Patent Application No. 2013-272349, filed Dec. 27, 2013. The contents of these applications are incorporated herein by reference in their entirety.

### FIELD

The present disclosure relates to a fuel cell system and a control method in which abnormality in the opening and closing operation of a purge valve for discharging water and impurities from a fuel gas passage is inspected.

### BACKGROUND

A fuel cell system includes a stack in which a plurality of cells are stacked. The cell includes a membrane/electrode assembly (an MEA) and a pair of separators respectively in contact with one face and the other face of the MEA. For example, the MEA includes a solid polymer electrolyte membrane, a cathode electrode in contact with one face of the solid polymer electrolyte membrane, and an anode electrode in contact with the other face of the solid polymer electrolyte membrane. For example, the fuel cell system is a solid polymer type fuel cell system including a solid polymer electrolyte membrane. In the fuel cell system, fuel gas (e.g., hydrogen) supplied to the anode electrode in each cell of the stack and oxidation gas (e.g., air) supplied to the cathode electrode react with each other so that electric power and water are generated.

Hydrogen ions move from the anode electrode through the solid polymer electrolyte membrane to the cathode electrode and hence water is generated in the cathode electrode of each cell. A part of the generated water is back-diffused from the cathode electrode through the solid polymer electrolyte membrane to the anode electrode. When the water is accumulated in the fuel gas passage, supply of the fuel gas to the stack is blocked. As a result, the generation efficiency of the fuel cell system is degraded. Further, the fuel gas contains impurities such as carbon monoxide. When the concentration of impurities in the anode surroundings in the stack increases in association with combustion of the fuel gas, the partial pressure of the fuel gas relatively decreases so that the electricity generation rate decreases.

In the fuel cell system of the conventional art, a purge valve is provided in the fuel gas passage. For example, in the case of a dead-end type fuel cell, the purge valve is provided in the downstream of the stack. Specifically, the purge valve is provided in a pipe through which the fuel gas discharged from the stack passes. Water and impurities accumulated in the fuel gas passage is discharged to the outside when the purge valve is opened. Such a fuel cell system has a function of inspecting abnormality in the purge valve. Here, the abnormality in the valve includes abnormality in opening operation and abnormality in closing operation. When the valve is normal, at the time that the valve receives an instruction of performing the opening operation, the valve performs the opening operation (that is, it switches from a closed state to an open state). However, when the opening operation of the valve is abnormal, at the time that the valve receives an instruction of performing the opening operation, the valve does not open and a closed state is maintained. When the valve is normal, at the time that the valve receives an instruction of performing the closing operation, the valve performs the closing operation (that is, it switches from an open state to a closed state). However, when the closing operation of the valve is abnormal, at the time that the valve receives an instruction of performing the closing operation, the valve does not close and an open state is maintained.

For example, Japanese Patent Laid-Open Publication No. 2003-92125 discloses a fuel cell system in which abnormality in the purge valve is inspected on the basis of the hydrogen pressure of a hydrogen circulation passage and the presence or absence of a purge instruction for hydrogen, during power generation of the fuel cell. In this fuel cell system, when the hydrogen pressure measured in a situation of absence of a hydrogen purge instruction is less than a threshold, the closing operation of the purge valve is determined as abnormal. Further, in the fuel cell system, when the hydrogen pressure measured in a situation of presence of a hydrogen purge instruction is greater than a threshold, the opening operation of the purge valve is determined as abnormal.

### SUMMARY

In the fuel cell system of the conventional art, for the purpose of inspecting abnormality in the purge valve, hydrogen had to be supplied to the hydrogen circulation passage. Tentatively, in a case that abnormality is present in the closing operation of the purge valve, presence of a fault can be recognized. However, since hydrogen is being supplied to the hydrogen circulation passage, there is a possibility that the hydrogen is discharged to the outside in association with the implementation of inspection.

An object of the present disclosure is to provide a fuel cell system in which normality or abnormality in a purge valve is allowed to be inspected by using oxidation gas.

To achieve the object, a fuel cell system according to an aspect of the present disclosure, in which fuel gas and oxidation gas are supplied respectively to an anode electrode and a cathode electrode of a membrane/electrode assembly so that electricity is generated, comprises: a stack in which a plurality of the membrane/electrode assemblies and a plurality of separators are stacked together; a fuel gas passage member in which the stack is arranged midway and a fuel gas supply source is connected to one end; an oxidation gas passage member in which the stack is arranged midway; an oxidation gas supply source connected to one end of the oxidation gas passage member; a substitution passage member which connects a first position located in the fuel gas passage member between the stack and the fuel gas supply source, and a second position located in the oxidation gas passage member between the stack and the oxidation gas supply source; a first valve arranged in the fuel gas passage member between the first position and the fuel gas supply source and allowed to switch between an open state and a closed state; a second valve arranged in the fuel gas passage member on a side opposite to the first valve with respect to the stack and allowed to switch between an open state and a closed state; a third valve arranged in the oxidation gas passage member on a side opposite to the oxidation gas supply source with respect to the stack and allowed to switch between an open state and a closed state; a fourth valve arranged in the substitution passage member and allowed to switch between an open state and a closed state; a detection part arranged in any one of the oxidation gas passage member between the oxidation gas supply source and the second position, the substitution passage member, and the fuel gas passage member on a side opposite to the first valve with respect to the first position, and then detecting flow of the oxidation gas; and a control part performing at least the following controls a) to d) at any timing,

a) a control of transmitting to the first valve and the third valve an instruction of performing closing operation of switching from the open state to the closed state,

b) a control of transmitting to the fourth valve an instruction of performing opening operation of switching from the closed state to the open state,

c) a control of transmitting to the oxidation gas supply source an instruction of supplying the oxidation gas, and

d) a control of, on the basis of a detection result of the detection part, determining whether the opening operation or the closing operation of the second valve is normal or abnormal.

A fuel cell system according to another aspect of the present disclosure, in which fuel gas and oxidation gas are supplied respectively to an anode electrode and a cathode electrode of a membrane/electrode assembly so that electricity is generated, comprises: a stack in which a plurality of the membrane/electrode assemblies and a plurality of separators are stacked together; a fuel gas passage member in which the stack is arranged midway and a fuel gas supply source is connected to one end; an oxidation gas passage member in which the stack is arranged midway; an oxidation gas supply source connected to one end of the oxidation gas passage member; a substitution passage member which connects a first position located in the fuel gas passage member between the stack and the fuel gas supply source, and a second position located in the oxidation gas passage member between the stack and the oxidation gas supply source; a first valve arranged in the fuel gas passage member between the first position and the fuel gas supply source, allowed to switch between an open state and a closed state, and remaining in the closed state in an initial state; a second valve arranged in the fuel gas passage member on a side opposite to the first valve with respect to the stack, allowed to switch between an open state and a closed state, and remaining in the closed state in an initial state; a third valve arranged in the oxidation gas passage member on a side opposite to the oxidation gas supply source with respect to the stack, allowed to switch between an open state and a closed state, and remaining in the closed state in an initial state; a fourth valve arranged in the substitution passage member, allowed to switch between an open state and a closed state, and remaining in the closed state in an initial state; a detection part arranged in any one of the oxidation gas passage member between the oxidation gas supply source and the second position, the substitution passage member, and the fuel gas passage member on a side opposite to the first valve with respect to the first position, and then detecting flow of the oxidation gas; and a control part which transmits to the fourth valve an instruction of performing opening operation of switching from the closed state to the open state, and determines whether the opening operation or the closing operation of the second valve is normal or abnormal based on the flow of the oxidation gas detected by the detection part when the oxidation gas is supplied and a threshold.

A control method according to further another aspect of the present disclosure, executed in a fuel cell system includes: a stack in which a plurality of membrane/electrode assemblies and a plurality of separators are stacked together; a fuel gas passage member in which the stack is arranged midway and a fuel gas supply source is connected to one end; an oxidation gas passage member in which the stack is arranged midway; an oxidation gas supply source connected to one end of the oxidation gas passage member; a substitution passage member which connects a first position located in the fuel gas passage member between the stack and the fuel gas supply source, and a second position located in the oxidation gas passage member between the stack and the oxidation gas supply source; a first valve arranged in the fuel gas passage member between the first position and the fuel gas supply source and allowed to switch between an open state and a closed state; a second valve arranged in the fuel gas passage member on a side opposite to the first valve with respect to the stack and allowed to switch between an open state and a closed state; a third valve arranged in the oxidation gas passage member on a side opposite to the oxidation gas supply source with respect to the stack and allowed to switch between an open state and a closed state; a fourth valve arranged in the substitution passage member and allowed to switch between an open state and a closed state; and a detection part arranged in any one of the oxidation gas passage member between the oxidation gas supply source and the second position, the substitution passage member, and the fuel gas passage member on a side opposite to the first valve with respect to the first position, and then detecting flow of the oxidation gas, wherein the method comprises: transmitting to the first valve and the third valve an instruction of performing closing operation of switching from the open state to the closed state; transmitting to the fourth valve an instruction of performing opening operation of switching from the closed state to the open state; and determining whether the opening operation or the closing operation of the second valve is normal or abnormal based on the flow of the oxidation gas detected by the detection part when the oxidation gas is supplied and a threshold.

According to the fuel cell system of the present disclosure, normality or abnormality in the purge valve can be inspected by using oxidation gas.

The above and further objects and features will more fully be apparent from the following detailed description with accompanying drawings.

### BRIEF DESCRIPTION OF THE DRAWINGS

FIG. 1 is a schematic diagram illustrating a configuration of a fuel cell system.

FIG. 2 is a perspective view illustrating a stack provided in the above-mentioned fuel cell system.

FIG. 3 is an exploded perspective view illustrating a configuration of the above-mentioned stack.

FIG. 4A is a plan view illustrating a front face of a separator constituting a cell. FIG. 4B is a plan view illustrating a back face of a separator constituting a cell.

FIG. 5 is a sectional partial view illustrating a configuration of the above-mentioned cell.

FIG. 6 is a block diagram illustrating an electrical configuration of a fuel cell system of the present disclosure.

FIG. 7 is a flow chart illustrating control processing for valve inspection according to a first embodiment of the present disclosure.

FIG. 8 is a flow chart illustrating control processing for valve inspection according to a second embodiment of the present disclosure.

### DETAILED DESCRIPTION

<Overall Configuration of System>

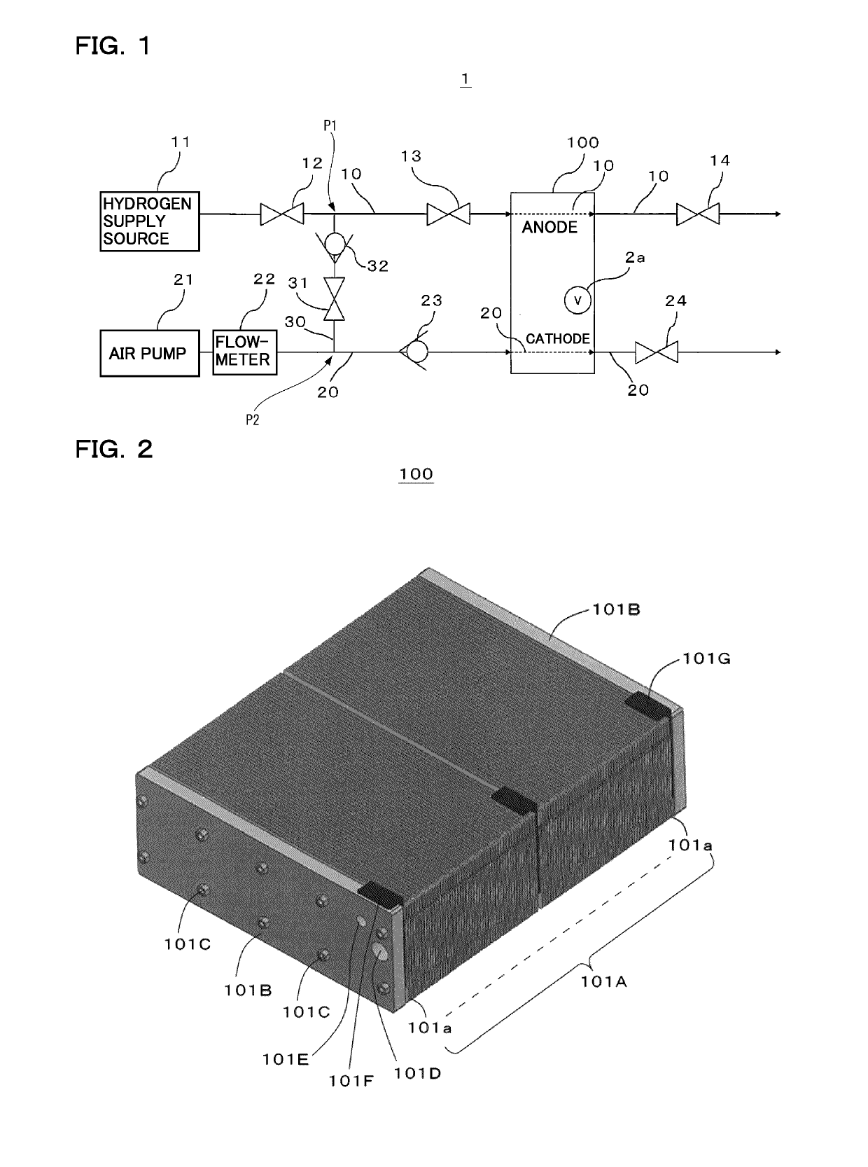

In FIG. 1, a fuel cell system 1 of the present embodiment includes a stack 100, a fuel gas passage member 10, an oxidation gas passage member 20, and a substitution passage member 30. The fuel gas passage member 10 is connected to an inlet and an outlet on the anode side of the stack 100. The oxidation gas passage member 20 is connected to an inlet and an outlet on the cathode side of the stack 100. That is, the stack 100 is arranged in the middle of the fuel gas passage member 10 and the oxidation gas passage member 20. The substitution passage member 30 connects a position (a first position P1 described later) located in the fuel gas passage member 10 between the stack 100 and a hydrogen supply source 11, and a position (a second position P2 described later) located in the oxidation gas passage member 20 between the stack 100 and an air pump 21. Here, the fuel cell system 1 may be a solid polymer type fuel cell system.

<<Configuration Relevant to Stack>>

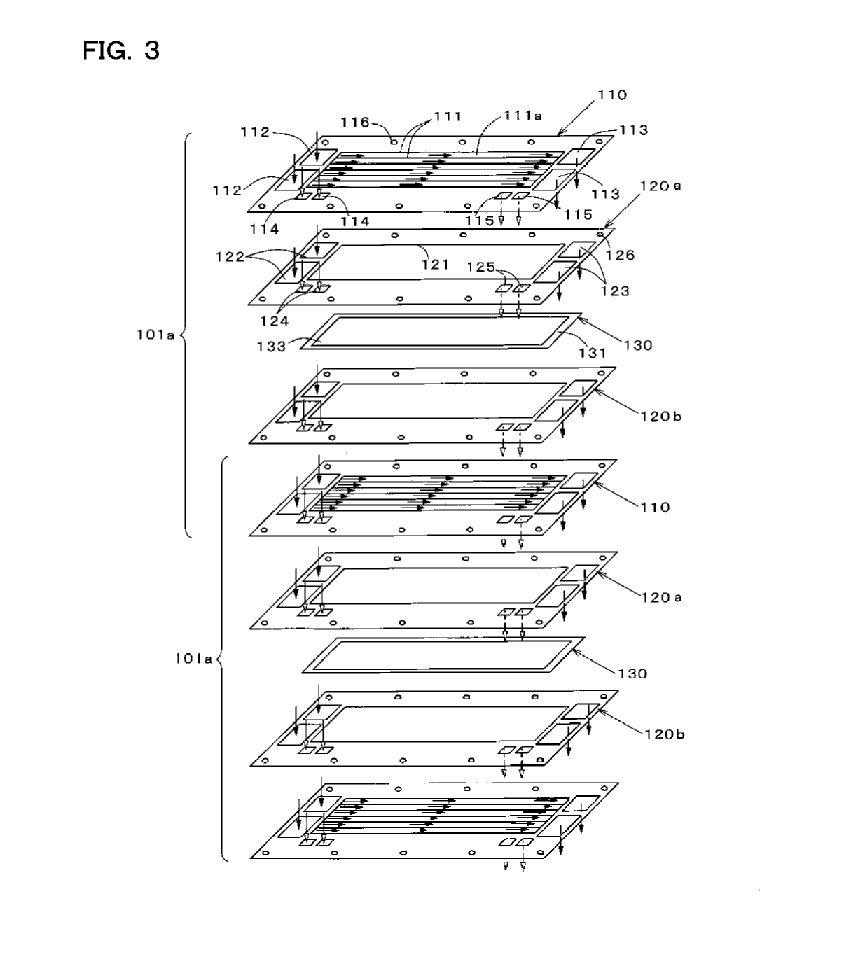

As illustrated in FIGS. 2 and 3, the stack 100 includes a plurality of cells 101a and two end plates 101B. The plurality of cells 101a constitute a cell group 101A stacked in series. One of the two end plates 101B is arranged at one end side of the cell group 101A. The other one of the two end plates 101B is arranged at the other end side of the cell group 101A. A plurality of bolts 101C pass through the plurality of cells 101a and the two end plates 101B so as to fix together the plurality of cells 101a and the two end plates 101B. In one end plate 101B, an air inlet hole 101D and a hydrogen inlet hole 101E are formed. The air inlet hole 101D is communicated with first through holes 112 of a separator 110 described later. The oxidation gas passage member 20 is connected to the air inlet hole 101D. The hydrogen inlet hole 101E is communicated with later-described third through holes 114 of the separator 110. The fuel gas passage member 10 is connected to the hydrogen inlet hole 101E. An air discharge hole (not illustrated) and a hydrogen discharge hole (not illustrated) are formed in the other end plate 101B. The air discharge hole is communicated with later-described second through holes 113 of the separator 110. The oxidation gas passage member 20 is connected to the air discharge hole. The hydrogen discharge hole is communicated with later-described fourth through holes 115 of the separator 110. The fuel gas passage member 10 is connected to the hydrogen discharge hole. A collecting electrode plate 101F is provided between one end plate 101B and the cell group 101A. A collecting electrode plate 101G is provided between the other end plate 101B and the cell group 101A. When an external electric load (such as an electric appliance) is electrically connected between the collecting electrode plate 101F and the collecting electrode plate 101G through a given voltage conversion circuit, the electric power generated by the stack 100 can be supplied to the external electric load.

As illustrated in FIGS. 3 to 5, each cell 101a constituting the stack 100 includes a membrane/electrode assembly 130, two gaskets 120a and 120b, and two separators 110. The two gaskets 120a and 120b are provided respectively in the peripheral edge part of the membrane/electrode assembly 130. One of the two separators 110 is in contact with one face of the membrane/electrode assembly 130 through a gasket 120a. The other one of the two separators 110 is in contact with the other face of the membrane/electrode assembly 130 through a gasket 120b.

<<<Membrane/Electrode Assembly>>>

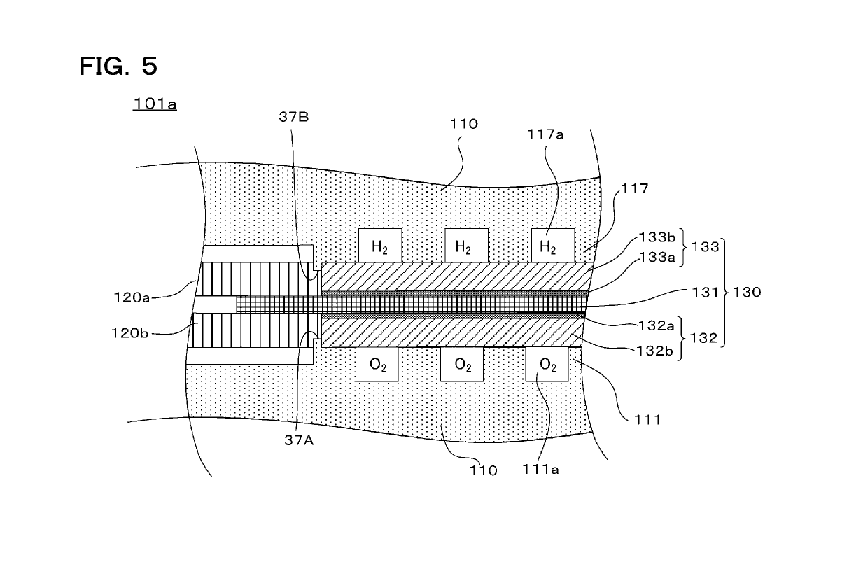

As illustrated in FIG. 5, the membrane/electrode assembly 130 includes a solid polymer electrolyte membrane (hereinafter, referred to as an electrolyte membrane) 131, a cathode electrode 132, and an anode electrode 133. The electrolyte membrane 131 has electrical conductivity for protons. The electrolyte membrane 131 selectively transports protons in a moisture state. The electrolyte membrane 131 is constructed from a fluorine-based polymer such as Nafion (registered tradename) having a sulfonic acid group.

The anode electrode 133 is in contact with one face of the electrolyte membrane 131. The anode electrode 133 includes a catalyst layer 133a and a gas the diffusion layer 133b. The gas diffusion layer 133b has electrical conductivity and permeability for the fuel gas, simultaneously. In the present embodiment, hydrogen is employed as an example of the fuel gas. However, it is sufficient that the fuel gas is a gas containing hydrogen. For example, the gas diffusion layer 133b is constructed from carbon paper or the like. The catalyst layer 133a is provided between one face of the electrolyte membrane 131 and the gas diffusion layer 133b. The catalyst layer 133a contains a catalyst composed mainly of carbon powder carrying a platinum-based metal catalyst. For example, the catalyst layer 133a is formed such that a paste in which a catalyst is dispersed in an organic solvent is applied on the carbon paper constituting the gas diffusion layer 133b.

The cathode electrode 132 is in contact with the other face of the electrolyte membrane 131. The cathode electrode 132 includes a catalyst layer 132a and a gas the diffusion layer 132b. The gas diffusion layer 132b has electrical conductivity and permeability for the oxidation gas, simultaneously. In the present embodiment, air is employed as an example of the oxidation gas. However, it is sufficient that the oxidation gas is a gas containing oxygen. For example, the gas diffusion layer 132b is constructed from carbon paper or the like. The catalyst layer 132a is provided between the other face of the electrolyte membrane 131 and the gas diffusion layer 132b. The catalyst layer 132a contains a catalyst composed mainly of carbon powder carrying a platinum-based metal catalyst. For example, the catalyst layer 132a is formed such that a paste in which a catalyst is dispersed in an organic solvent is applied on the carbon paper constituting the gas diffusion layer 132b.

<<<Separator>>>

The separator 110 is a member having a rectangular flat-plate shape. For example, the separator 110 is constructed from an electrically conductive material such as stainless steel, aluminum, and carbon. In the separator 110, formed are: a plurality of first passage walls 111, a plurality of second passage walls 117, two first through holes 112, two second through holes 113, two third through holes 114, and two fourth through holes 115.

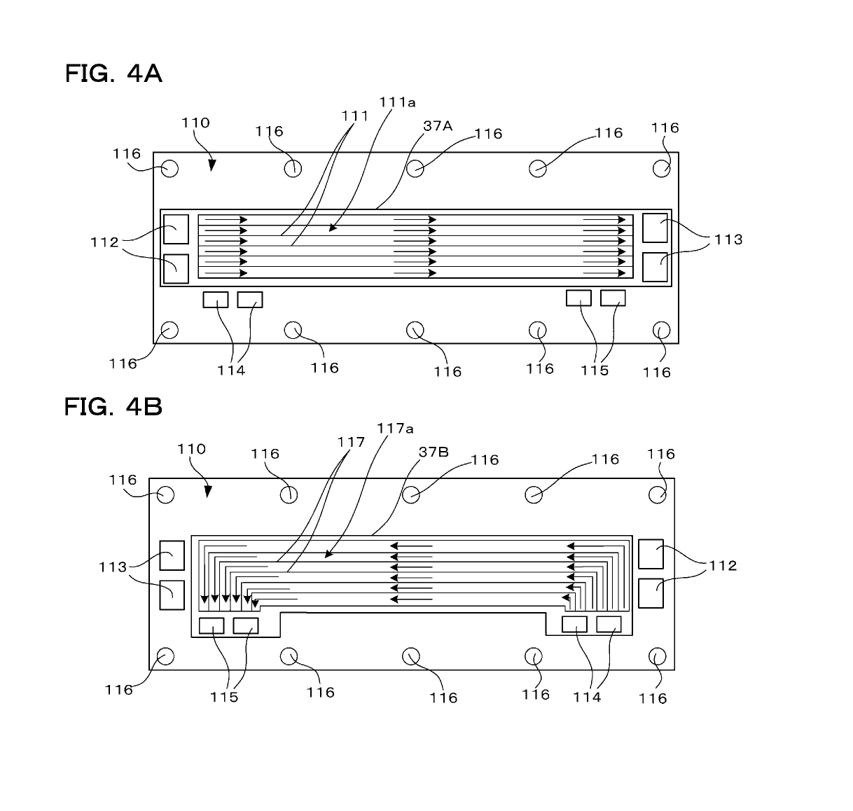

As illustrated in FIGS. 3 and 4, in the center in one face (e.g., the front face) of the separator 110, the plurality of first passage walls 111 are formed in parallel to each other with intervals in between. For example, the first passage wall 111 is a groove formed in the front face of the separator 110. The substantially rectangular region containing all the first passage walls 111 corresponds to the outer shape of the cathode electrode 132 of the membrane/electrode assembly 130. A plurality of first passages 111a in the stack 100 are formed by the individual first passage walls 111 and by the cathode electrode 132 in contact with each top in the protrusion between two adjacent first passage walls 111. At one end side of these first passages 111a, the two first through holes 112 are provided along the short side of the separator 110. Further, at the other end side of these first passages 111a, the two second through holes 113 are provided along the short side of the separator 110. The air having passed through the first through holes 112 flows through the first passages 111a and is then supplied to the cathode electrode 132. The air having flowed through the first passages 111a, together with water generated in the cathode electrode 132 in association with power generation, passes through the second through holes 113. A gasket line 37A protruding in the thickness direction is formed in the front face of the separator 110. The gasket line 37A surrounds the outer periphery of the plurality of first passage walls 111, the two first through holes 112, and the two second through holes 113 without a discontinuity.

Further, in the center in the other face (e.g., the back face) of the separator 110, similarly to the front face, the plurality of second passage walls 117 are provided in parallel to each other with intervals in between. For example, the second passage wall 117 is a groove formed in the back face of the separator 110. In contrast to the passage walls 111 of straight type in the front face, the plurality of second passage walls 117 are of serpentine type in which both ends are bent at right angles respectively toward the third through holes 114 and the fourth through holes 115. The substantially rectangular region containing the plurality of second passage walls 117 corresponds to the outer shape of the anode electrode 133 of the membrane/electrode assembly 130. A plurality of second passages 117a in the stack 100 are formed by the individual second passage walls 117 and by the anode electrode 133 in contact with each top in the protrusion between two adjacent second passage walls 117. The hydrogen having passed through the third through holes 114 flows through the second passages 117a and is then supplied to the anode electrode 133. The hydrogen having flowed through the second passages 117a passes through the fourth through holes 115. Similarly to the front face, a gasket line 37B protruding in the thickness direction is formed in the back face of the separator 110. The gasket line 37B surrounds the outer periphery of the plurality of second passages 117a, the two third through holes 114, and the two fourth through holes 115 without a discontinuity.

In the vicinity of each of the long sides opposite to each other in the separator 110, a plurality of through holes 116 are provided at equal intervals. In the present embodiment, for the purpose of improving the strength of the separator 110, the third through holes 114 and the fourth through holes 115 are provided individually in a region between two adjacent through holes 116.

<<<Gasket>>>

Each of the gaskets 120a and 120b is constructed from a rectangular sheet material having substantially the same size as the separator 110. Each of the gaskets 120a and 120b includes through holes 121 to 126. For example, the sheet material employed for forming the gaskets 120a and 120b may be an elastic material such as silicone rubber or elastomer formed remarkably thin. In the center of each of the gaskets 120a and 120b, a rectangular through hole 121 having the largest size is provided. The outer shape and the position of the through hole 121 correspond to those of a substantially rectangular region containing the plurality of first passage walls 111 formed in the front face of the separator 110 and the plurality of second passage walls 117 formed in the back face of the separator 110. Further, the outer shape of the through hole 121 corresponds also to the cathode electrode 132 and the anode electrode 133 provided in both faces of the electrolyte membrane 131.

In the vicinities of the short sides opposite to each other in each of the gaskets 120a and 120b, at both end sides of the rectangular through hole 121, two through holes 122 and two through holes 123 are respectively provided. The outer shapes and the positions of the two through holes 122 respectively correspond to those of the two first through holes 112 of the separator 110. Further, the outer shapes and the positions of the two through holes 123 respectively correspond to those of the two second through holes 113 of the separator 110.

In the vicinity of one long side of each of the gaskets 120a and 120b, two through holes 124 and two through holes 125 and are provided with intervals in between. The outer shapes and the positions of the two through holes 124 respectively correspond to those of the two third through holes 114 of the separator 110. Further, the outer shapes and the positions of the two through holes 125 respectively correspond to those of the two fourth through holes 115 of the separator 110.

In the vicinity of each of the long sides opposite to each other in each of the gaskets 120a and 120b, a plurality of through holes 126 are provided at equal intervals. The outer shapes and the positions of these through holes 126 respectively correspond to those of the individual through holes 116 of the separator 110.

As illustrated in FIGS. 3 and 5, the gasket 120a is located adjacent to the outer periphery of the anode electrode 133 and is in contact with one face of the electrolyte membrane 131. The gasket 120a is pressed down by the gasket line 37B formed in the back face of the separator 110. The gasket 120a avoids a situation that the hydrogen flowing through the second passages 117a leaks from the cell 101a to the outside. The gasket 120b is located adjacent to the outer periphery of the cathode electrode 132 and is in contact with the other face of the electrolyte membrane 131. The gasket 120b is pressed down by the gasket line 37A formed in the front face of the separator 110. The gasket 120b avoids a situation that the air flowing through the first passages 111a leaks from the cell 101a to the outside.

In FIGS. 2 and 3, the plurality of cells 101a are directly stacked and hence the first through holes 112 and the through holes 122 align in a straight line. Similarly, the third through holes 114 and the through holes 124, the second through holes 113 and the through holes 123, and the fourth through holes 115 and the through holes 125 individually align in a straight line. The hydrogen inlet hole 101E of one end plate 101B is communicated with the third through holes 114 and the through holes 124 aligned in straight lines. The air inlet hole 101D of one end plate 101B is communicated with the first through holes 112 and the through holes 122 aligned in straight lines. The hydrogen discharge hole (not illustrated) of the other end plate 101B is communicated with the fourth through holes 115 and the through holes 125 aligned in straight lines. The air discharge hole (not illustrated) of the other end plate 101B is communicated with the second through holes 113 and the through holes 123 aligned in straight lines.

<<Operation of Fuel Cell>>

The hydrogen supplied through the hydrogen inlet hole 101E to the inside of the stack 100 flows into the third through holes 114 aligned in straight lines in the stacking direction. The hydrogen flows through the third through holes 114 into the second passages 117a. The hydrogen having flowed into the second passages 117a is diffused in the plane direction of the membrane/electrode assembly 130 by the diffusion layer 133b of the anode electrode 133 and then goes into contact with the catalyst layer 133a of the anode electrode 133. The hydrogen in contact with the catalyst layer 133a is dissociated into hydrogen ions and electrons by the catalyst contained in the catalyst layer 133a. The hydrogen ions are conducted through the electrolyte membrane 131 and then reach the catalyst layer 132a of the cathode electrode 132. On the other hand, the electrons are extracted through the collecting electrode plate 101F to the outside. The hydrogen gas in contact with the anode electrode 133 goes along the second passages 117a to the fourth through holes 115 and is then discharged through the hydrogen discharge hole (not illustrated) to the outside of the stack 100.

The air supplied through the air inlet hole 101D to the inside of the stack 100 flows into the first through holes 112 aligned in straight lines in the stacking direction. The air flows through the first through holes 112 into the first passages 111a. The air having flowed into the first passages 111a is diffused in the plane direction of the membrane/electrode assembly 130 by the diffusion layer 132b of the cathode electrode 132 and then goes into contact with the catalyst layer 132a of the cathode electrode 132. By virtue of the catalyst contained in the catalyst layer 132a, the oxygen contained in the air reacts with the hydrogen ions having been conducted through the electrolyte membrane 131 and with the electrons having been extracted through the collecting electrode plate 101F and then conducted through an electric load from the collecting electrode plate 101G, so that water is generated. As a result of this electron transfer, electric power is generated. The air in contact with the cathode electrode 132, together with the generated water, goes along the first passages 111a to the second through holes 113 and is then discharged through the air discharge hole (not illustrated) to the outside of the stack 100.

<<Configuration Relevant to Fuel Gas Passage Member>>

In the outside of the stack 100, the fuel gas passage member 10 defines a passage for hydrogen serving as the fuel gas. The configuration of the fuel gas passage member 10 is not limited to a particular one as long as a passage for hydrogen is allowed to be defined. For example, as the fuel gas passage member 10, a hard or soft pipe, tube, or the like may be employed. For example, the construction material of such a hard pipe or tube may be metal such as stainless steel. For example, the construction material of such a soft pipe or tube may be engineering plastics or synthetic resin of diverse kind like polypropylene.

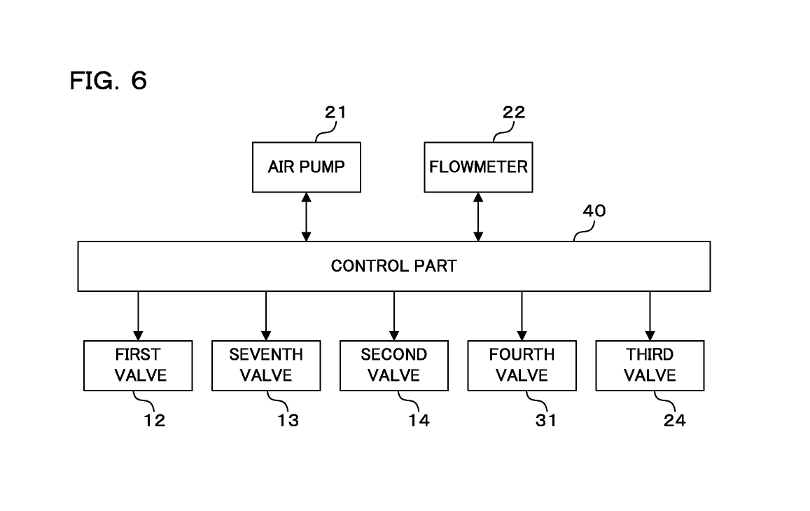

As illustrated in FIG. 1, in the fuel gas passage member 10, a hydrogen supply source 11 serving as a fuel gas supply source, a first valve 12, a seventh valve 13, a stack 100, and a second valve 14 are arranged in this order from the upstream in the direction of hydrogen flow. For example, each of the first valve 12, the seventh valve 13, and the second valve 14 is constructed from a solenoid valve allowed to switch between an open state and a closed state in response to an instruction (a signal) from a control part 40 illustrated in FIG. 6. Here, for example, the signal from the control part 40 indicates the state of an electric current supplied to each valve. For example, a state that a signal of switching to an open state is received indicates a state that a given electric current driving the solenoid is supplied to each valve. Further, a state that a signal of switching to a closed state is received indicates a state that a given electric current driving the solenoid is not supplied to each valve. That is, each of the first valve 12, the seventh valve 13, and the second valve 14 is a solenoid valve remaining in a closed state in the initial state and going into an open state in response to supply of an electric current. However, each of the first valve 12, the seventh valve 13, and the second valve 14 may be a solenoid valve remaining in an open state in the initial state and going into a closed state in response to supply of an electric current. Further, each of the first valve 12, the seventh valve 13, and the second valve 14 employed in implementation of the present disclosure is not limited to a solenoid valve. In implementation of the present disclosure, in place of such a solenoid valve, for example, an electrically operated valve whose opening state is allowed to be adjusted by a motor may be employed.

The hydrogen supply source 11 is arranged at or connected to the most upstream position of the fuel gas passage member 10. That is, the hydrogen supply source 11 is arranged at or connected to one end in the upstream of the fuel gas passage member 10. The hydrogen supply source 11 supplies hydrogen serving as the fuel gas to the fuel gas passage member 10. The configuration of the hydrogen supply source 11 is not limited to a particular one. That is, for example, a high pressure tank storing gas or liquid hydrogen or, alternatively, a low pressure tank containing a hydrogen absorbing alloy may be employed.

The first valve 12 is arranged in the fuel gas passage member 10 at a position located between the hydrogen supply source 11 and the substitution passage member 30 (specifically, a first position P1 described later). The first valve 12 goes into an open state at the time of startup of the fuel cell system 1 so as to cause the hydrogen supplied from the hydrogen supply source 11 to the stack 100 to flow into the fuel gas passage member 10. Further, the first valve 12 goes into a closed state at the time of termination of the fuel cell system 1 so as to shut off the hydrogen supplied from the hydrogen supply source 11 to the stack 100. When abnormality occurs in the closing operation of the second valve 14, the first valve 12 goes into a closed state so as to shut off the supply of hydrogen to the stack 100.

The seventh valve 13 is arranged in the fuel gas passage member 10 at a position located between the substitution passage member 30 and the stack 100. The seventh valve 13 goes into an open state at the time of startup of the fuel cell system 1 so as to cause the hydrogen supplied from the hydrogen supply source 11 to the stack 100 to flow into the fuel gas passage member 10. Further, the seventh valve 13 goes into a closed state at the time of termination of the fuel cell system 1 so as to shut off the hydrogen supplied from the hydrogen supply source 11 to the stack 100. When abnormality occurs in the closing operation of the second valve 14, the seventh valve 13 goes into a closed state so as to shut off the supply of hydrogen to the stack 100. That is, the first valve 12 and the seventh valve 13 doubly prevent the leakage of hydrogen caused by the abnormality in the closing operation of the second valve 14.

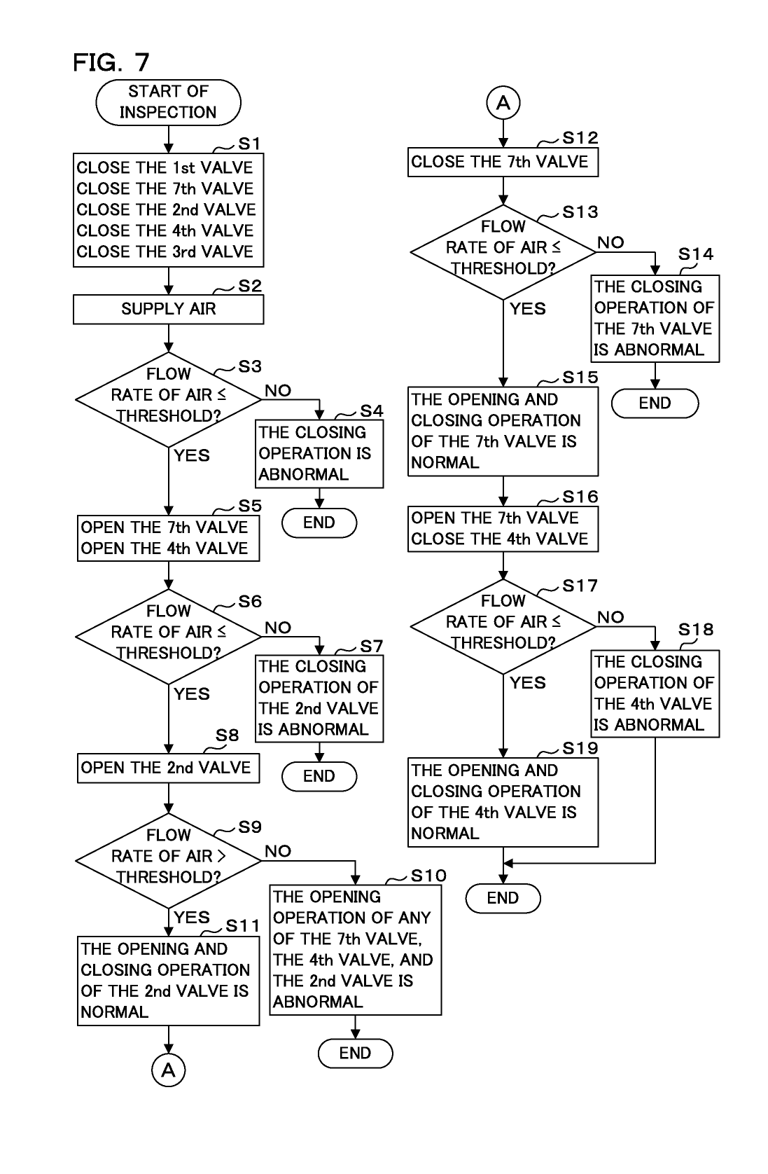

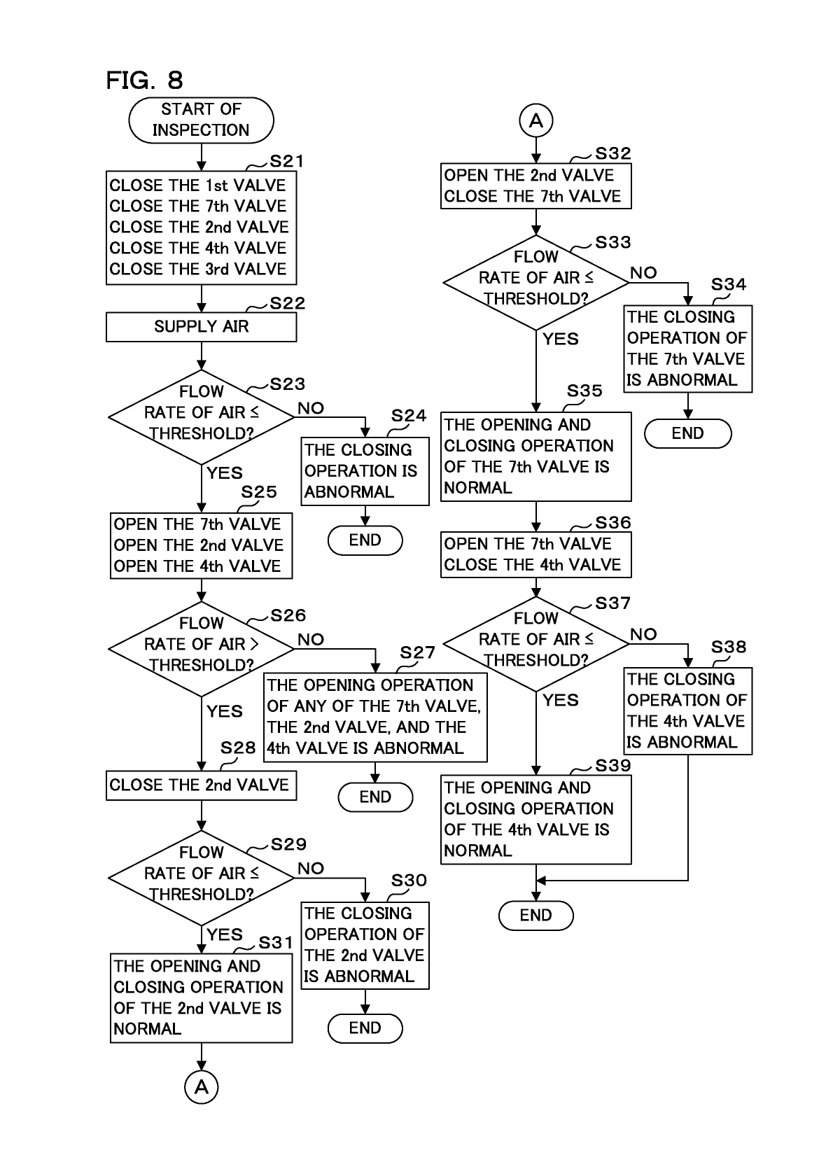

The second valve 14 is arranged in the fuel gas passage member 10 connected to the downstream side of the stack 100. In other words, the second valve 14 is arranged in the fuel gas passage member 10 on a side opposite to the first valve 12 with respect to the stack 100. Water generated by the stack 100 and impurities whose concentration has increased in association with power generation stagnate inside of the fuel gas passage member 10 connected to the downstream side of the stack 100. When being in an open state, the second valve 14 discharges the water and the impurities accumulated in the fuel gas passage member 10 together with hydrogen, to the outside. That is, the second valve 14 serves as a purge valve purging the hydrogen. When abnormality occurs in the opening operation of the second valve 14, water and impurities are not allowed to be discharged to the outside. Further, when abnormality occurs in the closing operation of the second valve 14, the hydrogen unintentionally leaks to the outside. Thus, in the fuel cell system 1 of the present embodiment, at the time of startup of the system, abnormality in the plurality of valves including the second valve 14 is inspected (see FIGS. 7 and 8).

<<Configuration Relevant to Oxidation Gas Passage Member>>

The oxidation gas passage member 20 defines a passage for air serving as the oxidation gas. The configuration of the oxidation gas passage member 20 is not limited to a particular one as long as a passage for air is allowed to be defined. For example, as the oxidation gas passage member 20, a hard or soft pipe, tube, or the like may be employed. For example, the construction material of such a hard pipe or tube may be metal such as stainless steel. For example, the construction material of such a soft pipe or tube may be engineering plastics or synthetic resin of diverse kind like polypropylene.

As illustrated in FIG. 1, in the oxidation gas passage member 20, an air pump 21, a flowmeter 22, a sixth valve 23, and a third valve 24 are arranged in this order from the upstream in the direction of air flow.

The air pump 21 is arranged at or connected to the most upstream position of the oxidation gas passage member 20. That is, the air pump 21 is arranged at or connected to one end in the upstream of the oxidation gas passage member 20. The air pump 21 supplies air serving as the oxidation gas, to the oxidation gas passage member 20. As illustrated in FIG. 6, for example, in response to an instruction (e.g., a signal) from the control part 40, the air pump 21 is controlled such as to be in any one of an operating state of supplying air to the oxidation gas passage member 20 and a stopped state of not supplying air to the oxidation gas passage member 20.

The flowmeter 22 is arranged in the oxidation gas passage member 20 at a position located between the air pump 21 and the substitution passage member 30. The flowmeter 22 is an example of the detection part detecting the flow of air. Specifically, the flowmeter 22 detects the flow rate of the air supplied to the oxidation gas passage member 20. The configuration of the flowmeter 22 is not limited to a particular one. Then, for example, a flowmeter of thermal type, differential pressure type, area type, ultrasonic type, or the like may be employed. The flowmeter 22 of the present embodiment is a flowmeter of thermal type employing a thermistor. As illustrated in FIG. 6, the flowmeter 22 detects the flow rate of the air supplied to the oxidation gas passage member 20 and then transmits the detection result to the control part 40. During the operation of the fuel cell, that is, during the time that at least the processing illustrated in FIGS. 7 and 8 is executed, the flowmeter 22 continues transmitting the detection result to the control part.

The sixth valve 23 permits a flow from one side of the oxidation gas passage member 20 to the other side and restricts a flow from the other side to the one side. In the present embodiment, the sixth valve 23 permits a flow from the upstream of the oxidation gas passage member 20 to the downstream, that is, from the air pump 21 side to the stack 100 side. The sixth valve 23 shuts off a flow from the downstream of the oxidation gas passage member 20 to the upstream, that is, from the stack 100 side to the air pump 21 side. As the sixth valve 23, for example, a check valve of arbitrary type such as poppet type, swing type, wafer type, lift type, ball type, and foot type may be employed. Here, as the sixth valve 23, a solenoid valve may be employed in place of such a check valve.

The third valve 24 is arranged in the oxidation gas passage member 20 connected to the downstream side of the stack 100. In other words, the third valve 24 is arranged in the oxidation gas passage member 20 on a side opposite to the air pump 21 with respect to the stack 100. When being in an open state, the third valve 24 discharges to the outside the water generated on the cathode side of the stack 100, together with air. Here, at the time that abnormality in the plurality of valves including the second valve 14 described above is to be inspected, the third valve 24 goes into a closed state so as to shut off discharge of the air from the oxidation gas passage member 20 to the outside. As illustrated in FIG. 6, for example, the third valve 24 is constructed from a solenoid valve allowed to switch between an open state and a closed state in response to an instruction (a signal) from the control part 40. Similarly to the first valve 12, the seventh valve 13, and the second valve 14, the third valve 24 is a solenoid valve remaining in a closed state in the initial state and going into an open state in response to supply of an electric current. However, the third valve 24 may be a solenoid valve remaining in an open state in the initial state and going into a closed state in response to supply of an electric current. Further, the third valve 24 employed in implementation of the present disclosure is not limited to a solenoid valve. In implementation of the present disclosure, in place of such a solenoid valve, for example, an electrically operated valve whose opening state is allowed to be adjusted by a motor may be employed.

<<Configuration Relevant to Substitution Passage Member>>

The substitution passage member 30 is used for causing air to flow from the oxidation gas passage member 20 to the fuel gas passage member 10. The configuration of the substitution passage member 30 is not limited to a particular one as long as a substitution passage through which the air flows is allowed to be defined. For example, as the substitution passage member 30, a hard or soft pipe, tube, or the like may be employed.

As illustrated in FIG. 1, the substitution passage member 30 connects a first position P1 located in the fuel gas passage member 10 between the stack 100 and the hydrogen supply source 11, and a second position P2 located in the oxidation gas passage member 20 between the stack 100 and the air pump 21. Specifically, the first position P1 of the fuel gas passage member 10 is located between the first valve 12 and the seventh valve 13. The second position P2 of the oxidation gas passage member 20 is located between the flowmeter 22 and the sixth valve 23. A fourth valve 31 is arranged on the oxidation gas passage member 20 side of the substitution passage member 30. A fifth valve 32 is arranged on the fuel gas passage member 10 side of the substitution passage member 30. For example, the construction material of such a hard pipe or tube may be metal such as stainless steel. For example, the construction material of such a soft pipe or tube may be engineering plastics or synthetic resin of diverse kind like polypropylene.

The fourth valve 31 is used for causing the fuel gas passage member 10 and the oxidation gas passage member 20 to be in fluid communication with each other or shut off from each other. As illustrated in FIG. 6, for example, the fourth valve 31 is constructed from a solenoid valve allowed to switch between an open state and a closed state in response to an instruction (a signal) from the control part 40. Similarly to the first valve 12, the seventh valve 13, and the second valve 14, the fourth valve 31 is a solenoid valve remaining in a closed state in the initial state and going into an open state in response to supply of an electric current. However, the fourth valve 31 may be a solenoid valve remaining in an open state in the initial state and going into a closed state in response to supply of an electric current. Further, the fourth valve 31 employed in implementation of the present disclosure is not limited to a solenoid valve. In implementation of the present disclosure, in place of such a solenoid valve, for example, an electrically operated valve whose opening state is allowed to be adjusted by a motor may be employed.

At the time that abnormality in the plurality of valves including the second valve 14 described above is to be inspected, in accordance with the instruction from the control part 40, the fourth valve 31 goes into an open state so as to cause the fuel gas passage member 10 and the oxidation gas passage member 20 to be in fluid communication with each other. By virtue of this, an inspection route is defined that passes through the oxidation gas passage member 20, the substitution passage member 30, and the fuel gas passage member 10. Specifically, the inspection route is defined by: the oxidation gas passage member 20 between the air pump 21 and the second position P2; the substitution passage member 30; and the fuel gas passage member 10 on a side opposite to the first position P1 with respect to the first valve 12. At that time, the air supplied from the air pump 21 flows from the oxidation gas passage member 20 through the substitution passage member 30 to the fuel gas passage member 10. In accordance with the instruction from the control part 40, the fourth valve 31 goes into a closed state so as to shut off the fuel gas passage member 10 and the oxidation gas passage member 20 from each other. By virtue of this, the air supplied from the air pump 21 flows through the oxidation gas passage member 20 to the cathode side of the stack 100.

The fifth valve 32 permits a flow from one side of the substitution passage member 30 to the other side and restricts a flow from the other side to the one side. That is, the fifth valve 32 permits the flow of air from the oxidation gas passage member 20 to the fuel gas passage member 10. The fifth valve 32 shuts off the flow of hydrogen from the fuel gas passage member 10 to the oxidation gas passage member 20. As the fifth valve 32, for example, a check valve of arbitrary type such as poppet type, swing type, wafer type, lift type, ball type, and foot type may be employed. Here, as the fifth valve 32, a solenoid valve may be employed in place of such a check valve.

<<Control Part>>

The control part 40 illustrated in FIG. 6 is electrically connected to the first valve 12, the seventh valve 13, the second valve 14, the third valve 24, the fourth valve 31, the air pump 21, and the flowmeter 22. The control part 40 transmits an instruction so as to control the opening and closing operation of the first valve 12, the seventh valve 13, the second valve 14, the third valve 24, and the fourth valve 31. Further, the control part 40 transmits an instruction so as to control the operation of the air pump 21. Further, the control part 40 receives the detection result from the flowmeter 22. On the basis of the detection result received from the flowmeter 22, the control part 40 executes the processing of inspecting abnormality in the plurality of valves including the second valve 14. For example, the control part 40 is a circuit board containing: a microcomputer including a CPU and a storage part; and various electric circuits. For example, the various electric circuits include: driver circuits driving the first valve 12, the seventh valve 13, the second valve 14, the third valve 24, the fourth valve 31, and the air pump 21; conversion circuits converting the analog signal from the flowmeter 22 and then inputting it to the microcomputer; and the like. The storage part stores a dedicated program used for executing control processing in FIGS. 7 and 8 described later. For example, the storage part is a ROM, a RAM, or the like. Here, the control part 40 may include a dedicated electronic circuit (e.g., an ASIC) for executing the control processing in FIGS. 7 and 8, in place of or in addition to the microcomputer.

Here, in the present embodiment, the one control part 40 controls the opening and closing operation of the first valve 12, the seventh valve 13, the second valve 14, the third valve 24, and the fourth valve 31 and inspects abnormality in the plurality of valves including the second valve 14. However, the configuration of the fuel cell system of the present disclosure is not limited to the one provided with the one control part 40. The fuel cell system of the present disclosure may have a configuration that opening and closing control of the valves and inspection of abnormality in the valves are performed by a plurality of control parts.

<Control Processing for Valve Inspection According to First Embodiment>

Next, control processing for valve inspection according to a first embodiment of the present disclosure is described below with reference to FIG. 7. As described below, in the fuel cell system 1 of the present embodiment, the opening and closing operation of the second valve 14 is inspected by using the air supplied from the air pump 21. The control processing for valve inspection may be executed at an arbitrary timing like at the time of startup of the fuel cell system 1 and at the time of operation.

Steps S1 to S19 illustrated in FIG. 7 are executed by the control part 40 illustrated in FIG. 6. Here, as described above, a configuration may be employed that the steps S1 to S19 illustrated in FIG. 7 are executed by a plurality of control parts.

<<Outline of Control Processing for Valve Inspection>>

The flow of control processing for valve inspection according to the present embodiment is briefly described below. At steps S1 to S4 illustrated in FIG. 7, the closing operation of the plurality of valves provided in the fuel cell system 1 is inspected. If abnormality has not been found in this inspection, at steps S5 to S11, the opening and closing operation of the second valve 14 and the opening operation of the seventh valve 13 and the fourth valve 31 are inspected. If abnormality has not been found in this inspection, at steps S12 to S15, the closing operation of the seventh valve 13 is inspected. If abnormality has not been found in this inspection, the closing operation of the fourth valve 31 is inspected. If abnormality has not been found in this inspection, it is concluded that the opening and closing operation of the plurality of valves provided in the fuel cell system 1 has been achieved normally. If abnormality has been found in any of the valves, the control processing for valve inspection is terminated at this time point.

<<Inspection of Closing Operation of Plurality of Valves>>

As illustrated at steps S1 to S4 of FIG. 7, the control part 40 first inspects abnormality in the closing operation of the first valve 12, the seventh valve 13, the second valve 14, the fourth valve 31, and the third valve 24. In the fuel cell system, it is remarkably important that leakage of hydrogen having flammability is prevented. Thus, in the fuel cell system 1 of the present embodiment, abnormality in the closing operation of the plurality of valves including the second valve 14 is inspected first.

At step S1, the control part 40 transmits an instruction of performing the closing operation to all of the first valve 12, the seventh valve 13, the second valve 14, the fourth valve 31, and the third valve 24. Here, in a case that the control processing for valve inspection is to be executed at the time of startup of the fuel cell system 1, it is expected that all valves are already in a closed state. Thus, in a case that the control processing for valve inspection is to be executed at the time of startup of the fuel cell system 1, step S1 may be not included. Then, the control part 40 advances the control processing to step S2. At step S2, the control part 40 transmits an instruction to the air pump 21 so as to supply air to the oxidation gas passage member 20. The flow rate of air is detected by the flowmeter 22. The control part 40 receives the detection result of the flowmeter 22.

Then, the control part 40 advances the control processing to step S3. At step S3, on the basis of the detection result received from the flowmeter 22, the control part 40 determines whether or not the flow rate of the air is less than or equal to a threshold. Here, as the threshold at step S3, a value somewhat exceeding 0 [liter/min] is adopted. That is, at step S1, if the closing operation of the first valve 12, the seventh valve 13, the second valve 14, the fourth valve 31, and the third valve 24 has been achieved normally, the air does not flow into the oxidation gas passage member 20 and hence, ideally, the flow rate of the air is expected to be 0 liter/min. Tentatively, in a case that the flow rate of the air exceeds 0 [liter/min], this indicates that the air flows into the oxidation gas passage member 20. That is, the situation that the flow rate of the air exceeds 0 [liter/min] indicates any of a situation that the closing operation of the third valve 24 has not been achieved normally and a situation that the closing operation of the seventh valve 13, the second valve 14, and the fourth valve 31 has not been achieved normally. However, in practice, even in a normal state, the first valve 12, the seventh valve 13, the second valve 14, the fourth valve 31, and the third valve 24 have a leakage of approximately 0.01 [liter/min] or smaller. Thus, as the threshold at step S3, a value of 0+α [liter/min] (e.g., 0.1 [liter/min]) is adopted with taking into consideration the normal leakage in these valves.

At step S3, if it is determined that the flow rate of the air is greater than the threshold (NO), the control part 40 advances the control processing to step S4. At step S4, the control part 40 determines that the situation is any of a situation that the closing operation of the third valve 24 has not been achieved normally and a situation that the closing operation of the seventh valve 13, the second valve 14, and the fourth valve 31 has not been achieved normally. The control part 40 stores the determination result into the storage part of the control part 40 or alternatively notifies it through a given information part. After that, the control part 40 terminates the control processing.

<<Inspection of Closing Operation of Second Valve>>

On the other hand, at step S3, if it is determined that the flow rate of the air is less than or equal to the threshold (YES), the control part 40 advances the control processing to step S5. At step S5, the control part 40 transmits an instruction of performing the opening operation to the seventh valve 13 and the fourth valve 31. Tentatively, in a case that the opening operation of the seventh valve 13 and the fourth valve 31 has been achieved normally, it is expected that an inspection route passing through the oxidation gas passage member 20, the substitution passage member 30, and the fuel gas passage member 10 is formed. The flow rate of the air flowing through the inspection route is detected by the flowmeter 22. The control part 40 receives the detection result of the flowmeter 22.

Then, the control part 40 advances the control processing to step S6. At step S6, on the basis of the detection result received from the flowmeter 22, the control part 40 determines whether or not the flow rate of the air is less than or equal to a threshold. A threshold value identical to that at step S3 is employed also at step S6. This is because, if the closing operation of the second valve 14 at step S1 has been achieved normally, the flow rate of the air becomes less than or equal to 0.1 [liter/min].

At step S6, if it is determined that the flow rate of the air is greater than the threshold (NO), the control part 40 advances the control processing to step S7. As a result of the processing of step S5, the seventh valve 13 and the fourth valve 31 are in an open state. On the other hand, the second valve 14 is in a closed state as a result of the control processing of step S1. In this state, a situation that the flow rate of the air is greater than the threshold indicates that the closing operation of the second valve 14 at step S1 has not been achieved normally. Thus, at step S7, the control part 40 determines that the closing operation of the second valve 14 is abnormal. The control part 40 stores the determination result into the storage part of the control part 40 or alternatively notifies it through a given information part. After that, the control part 40 terminates the control processing.

<<Inspection of Opening Operation of Second Valve>>

On the other hand, at step S6, if it is determined that the flow rate of the air is less than or equal to the threshold (YES), the control part 40 advances the control processing to step S8. At step S8, the control part 40 transmits an instruction of performing opening operation to the second valve 14. Tentatively, in a case that the opening operation of the second valve 14 has been achieved normally, it is expected that the air supplied from the air pump 21 is discharged through the oxidation gas passage member 20, the substitution passage member 30, and the fuel gas passage member 10 (the inspection route) to the outside. The flow rate of the air flowing through the inspection route is detected by the flowmeter 22. The control part 40 receives the detection result of the flowmeter 22.

Then, the control part 40 advances the control processing to step S9. At step S9, on the basis of the detection result received from the flowmeter 22, the control part 40 determines whether or not the flow rate of the air is greater than a threshold. A threshold value identical to those at steps S3 and S6 is employed also at step S9. This is because, in a case that the opening operation of the seventh valve 13 and the fourth valve 31 at step S5 has been achieved normally and then the opening operation of the second valve 14 at step S8 has been achieved normally, the flow rate of the air becomes greater than 0.1 [liter/min].

At step S9, if it is determined that the flow rate of the air is less than or equal to the threshold (NO), the control part 40 advances the control processing to step S10. As a result of the processing of step S8, the second valve 14 is in an open state. On the other hand, the seventh valve 13 and the fourth valve 31 are also in an open state as a result of the control processing of step S5. In this state, a situation that the flow rate of the air is less than or equal to the threshold indicates that the opening operation of at least one valve has not been achieved normally. Thus, at step S10, the control part 40 determines that the opening operation of any of the seventh valve 13, the fourth valve 31, and the second valve 14 is abnormal. The control part 40 stores the determination result into the storage part of the control part 40 or alternatively notifies it through a given information part. After that, the control part 40 terminates the control processing.

On the other hand, at step S9, if it is determined that the flow rate of the air is greater than the threshold (YES), the control part 40 advances the control processing to step S11. At step S11, the control part 40 determines that the opening and closing operation of the second valve 14 is normal. The control part 40 stores the determination result into the storage part of the control part 40.

Further, if the determination result at step S9 is “YES”, this situation indicates that the opening operation of the seventh valve 13 and the fourth valve 31 at step S5 is normal. However, in the control processing to steps S1 to S11, it is not allowed to determine whether the closing operation of the seventh valve 13 and the fourth valve 31 is normal or abnormal. Thus, subsequently to the step S11, the control part 40 executes the following control processing for the purpose of inspecting the closing operation of the seventh valve 13 and the fourth valve 31.

<<Inspection of Closing Operation of Seventh Valve>>

The control part 40 advances the control processing to step S12. At step S12, the control part 40 transmits an instruction of performing closing operation to the seventh valve 13. Tentatively, in a case that the closing operation of the seventh valve 13 has been achieved normally, the fuel gas passage member 10 is shut off in the upstream of the stack 100. As a result, the air is expected not to flow through the inspection route. The flow rate of the air flowing through the inspection route is detected by the flowmeter 22. The control part 40 receives the detection result of the flowmeter 22.

Then, the control part 40 advances the control processing to step S13. At step S13, on the basis of the detection result received from the flowmeter 22, the control part 40 determines whether or not the flow rate of the air is less than or equal to a threshold. A threshold value identical to those at steps S3, S6, and S9 is employed also at step S13. This is because, if the closing operation of the seventh valve 13 at step S12 has been achieved normally, the flow rate of the air becomes less than or equal to 0.1 [liter/min].

At step S13, if it is determined that the flow rate of the air is greater than the threshold (NO), the control part 40 advances the control processing to step S14. At step S14, the control part 40 determines that the closing operation of the seventh valve 13 is abnormal. The control part 40 stores the determination result into the storage part of the control part 40 or alternatively notifies it through a given information part. After that, the control part 40 terminates the control processing.

On the other hand, at step S13, if it is determined that the flow rate of the air is less than or equal to the threshold (YES), the control part 40 advances the control processing to step S15. At step S15, the control part 40 determines that the opening and closing operation of the seventh valve 13 is normal. The control part 40 stores the determination result into the storage part of the control part 40.

<<Inspection of Closing Operation of Fourth Valve>>

The control part 40 advances the control processing to step S16. At step S16, the control part 40 transmits an instruction of performing opening the operation to the seventh valve 13 and transmits an instruction of performing the closing operation to the fourth valve 31. Tentatively, in a case that the closing operation of the fourth valve 31 has been achieved normally, the substitution passage member 30 is shut off midway. As a result, the air is expected not to flow through the inspection route. The flow rate of the air flowing through the inspection route is detected by the flowmeter 22. The control part 40 receives the detection result of the flowmeter 22.

Then, the control part 40 advances the control processing to step S17. At step S17, on the basis of the detection result received from the flowmeter 22, the control part 40 determines whether or not the flow rate of the air is less than or equal to a threshold. A threshold value identical to those at steps S3, S6, S9, and S13 is employed also at step S17. This is because, if the closing operation of the fourth valve 31 at step S16 has been achieved normally, the flow rate of the air becomes less than or equal to 0.1 [liter/min].

At step S17, if it is determined that the flow rate of the air is greater than the threshold (NO), the control part 40 advances the control processing to step S18. At step S18, the control part 40 determines that the closing operation of the fourth valve 31 is abnormal. The control part 40 stores the determination result into the storage part of the control part 40 or alternatively notifies it through a given information part. After that, the control part 40 terminates the control processing.

On the other hand, at step S17, if it is determined that the flow rate of the air is less than or equal to the threshold (YES), the control part 40 advances the control processing to step S19. At step S19, the control part 40 determines that the opening and closing operation of the fourth valve 31 is normal. The control part 40 stores the determination result into the storage part of the control part 40. After that, the control part 40 terminates the control processing.

<Control Processing for Valve Inspection According to Second Embodiment>

Next, control processing for valve inspection according to a second embodiment of the present disclosure is described below with reference to FIG. 8. Similarly to the first embodiment given above, in the fuel cell system 1 of the second embodiment, the opening and closing operation of the second valve 14 is inspected by using the air supplied from the air pump 21.

Steps S21 to S39 illustrated in FIG. 8 are executed by the control part 40 illustrated in FIG. 6. Here, as described above, a configuration may be employed that the steps S21 to S39 illustrated in FIG. 8 are executed by a plurality of control parts.

In the control processing of the first embodiment given above, the closing operation of the second valve 14 is inspected first (steps S5 to S7 of FIG. 7) and, after that, the opening operation of the second valve 14 is inspected (steps S8 to S11 of FIG. 7). In contrast, in the control processing of the second embodiment given above, the opening operation of the second valve 14 is inspected first (steps S25 to S27 of FIG. 8) and, after that, the closing operation of the second valve 14 is inspected (steps S28 to S31 of FIG. 8).

<<Inspection of Closing Operation of Plurality of Valves>>

Steps S21 to S24 in FIG. 8 are the same control processing as that at steps S1 to S4 in FIG. 7 of the first embodiment. At step S21, first, the control part 40 transmits an instruction of performing the closing operation to all of the first valve 12, the seventh valve 13, the second valve 14, the fourth valve 31, and the third valve 24. At step S22, the control part 40 transmits an instruction to the air pump 21 so as to supply air to the oxidation gas passage member 20. At step S23, on the basis of the detection result received from the flowmeter 22, the control part 40 determines whether or not the flow rate of the air is less than or equal to a threshold. Similarly to the first embodiment, the threshold at step S23 is 0.1 [liter/min].

At step S23, if it is determined that the flow rate of the air is greater than the threshold (NO), the control part 40 advances the control processing to step S24. As a result of the control processing of step S21, the first valve 12, the seventh valve 13, the second valve 14, the fourth valve 31, and the third valve 24 are all in a closed state. In this state, a situation that the flow rate of the air is greater than the threshold indicates that the closing operation of any of the plurality of valves at step S21 has not been achieved normally. Thus, at step S24, the control part 40 determines that the situation is any of a situation that the closing operation of the third valve 24 has not been achieved normally and a situation that the closing operation of the seventh valve 13, the second valve 14, and the fourth valve 31 has not been achieved normally. The control part 40 stores the determination result into the storage part of the control part 40 or alternatively notifies it through a given information part. After that, the control part 40 terminates the control processing.

<<Inspection of Opening Operation of Second Valve>>

On the other hand, at step S23, if it is determined that the flow rate of the air is less than or equal to the threshold (YES), the control part 40 advances the control processing to step S25. At step S25, the control part 40 transmits an instruction of performing the opening operation to the seventh valve 13, the second valve 14, and the fourth valve 31. Tentatively, in a case that the opening operation of the seventh valve 13, the second valve 14, and the fourth valve 31 has been achieved normally, it is expected that an inspection route passing through the oxidation gas passage member 20, the substitution passage member 30, and the fuel gas passage member 10 is formed. The flow rate of the air flowing through the inspection route is detected by the flowmeter 22. The control part 40 receives the detection result of the flowmeter 22.

Then, the control part 40 advances the control processing to step S26. At step S26, on the basis of the detection result received from the flowmeter 22, the control part 40 determines whether or not the flow rate of the air is greater than a threshold. A threshold value identical to that at step S23 is employed also at step S26. This is because, if the opening operation of the seventh valve 13, the second valve 14, and the fourth valve 31 at step S25 has been achieved normally, the flow rate of the air becomes greater than 0.1 [liter/min].

At step S26, if it is determined that the flow rate of the air is less than or equal to the threshold (NO), the control part 40 advances the control processing to step S27. At step S27, the control part 40 determines that the opening operation of any of the seventh valve 13, the second valve 14, and the fourth valve 31 is abnormal. The control part 40 stores the determination result into the storage part of the control part 40 or alternatively notifies it through a given information part. After that, the control part 40 terminates the control processing.

<<Inspection of Closing Operation of Second Valve>>

On the other hand, at step S26, if it is determined that the flow rate of the air is greater than the threshold (YES), the control part 40 advances the control processing to step S28. Here, if the determination result at step S26 is “YES”, this situation indicates that the opening operation of the seventh valve 13, the second valve 14, and the fourth valve 31 at step S25 is normal.

At step S28, the control part 40 transmits an instruction of performing the closing operation to the second valve 14. Tentatively, in a case that the closing operation of the second valve 14 has been achieved normally, the fuel gas passage member 10 is shut off in the downstream of the stack 100. As a result, the air is expected not to flow through the inspection route. The flow rate of the air flowing through the inspection route is detected by the flowmeter 22. The control part 40 receives the detection result of the flowmeter 22.

Then, the control part 40 advances the control processing to step S29. At step S29, on the basis of the detection result received from the flowmeter 22, the control part 40 determines whether or not the flow rate of the air is less than or equal to a threshold. A threshold value identical to those at steps S23 and S26 is employed also at step S29. This is because, if the closing operation of the second valve 14 at step S28 has been achieved normally, the flow rate of the air becomes less than or equal to 0.1 [liter/min].

At step S29, if it is determined that the flow rate of the air is greater than the threshold (NO), the control part 40 advances the control processing to step S30. At step S30, the control part 40 determines that the closing operation of the second valve 14 is abnormal. The control part 40 stores the determination result into the storage part of the control part 40 or alternatively notifies it through a given information part. After that, the control part 40 terminates the control processing.

On the other hand, at step S29, if it is determined that the flow rate of the air is less than or equal to the threshold (YES), the control part 40 advances the control processing to step S31. At step S31, the control part 40 determines that the opening and closing operation of the second valve 14 is normal. The control part 40 stores the determination result into the storage part of the control part 40.

As described above, if the determination result at step S26 is “YES”, this situation indicates that the opening operation of the seventh valve 13, the second valve 14, and the fourth valve 31 at step S25 is normal. However, in the control processing to steps S21 to S31, it is not allowed to determine whether the closing operation of the seventh valve 13 and the fourth valve 31 is normal or abnormal. Thus, similarly to the first embodiment, subsequently to the step S31, the control part 40 executes the following control processing for the purpose of inspecting the closing operation of the seventh valve 13 and the fourth valve 31.

<<Inspection of Closing Operation of Seventh Valve>>

Steps S32 to S34 of FIG. 8 are the same control processing as that at steps S12 to S14 of FIG. 7 of the first embodiment except for a point that the opening operation of the second valve 14 is performed at step S32.

The control part 40 advances the control processing to step S32. At step S32, the control part 40 transmits an instruction of performing opening the operation to the second valve 14 and transmits an instruction of performing the closing operation to the seventh valve 13. Tentatively, in a case that the closing operation of the seventh valve 13 has been achieved normally, the fuel gas passage member 10 is shut off in the upstream of the stack 100. As a result, the air is expected not to flow through the inspection route. The flow rate of the air flowing through the inspection route is detected by the flowmeter 22. The control part 40 receives the detection result of the flowmeter 22.

Then, the control part 40 advances the control processing to step S33. At step S33, on the basis of the detection result received from the flowmeter 22, the control part 40 determines whether or not the flow rate of the air is less than or equal to a threshold. A threshold value identical to those at steps S23, S26, and S29 is employed also at step S33. This is because, if the closing operation of the seventh valve 13 at step S32 has been achieved normally, the flow rate of the air becomes less than or equal to 0.1 [liter/min].

At step S33, if it is determined that the flow rate of the air is greater than the threshold (NO), the control part 40 advances the control processing to step S34. At step S34, the control part 40 determines that the closing operation of the seventh valve 13 is abnormal. The control part 40 stores the determination result into the storage part of the control part 40 or alternatively notifies it through a given information part. After that, the control part 40 terminates the control processing.

On the other hand, at step S33, if it is determined that the flow rate of the air is less than or equal to the threshold (YES), the control part 40 advances the control processing to step S35. At step S35, the control part 40 determines that the opening and closing operation of the seventh valve 13 is normal. The control part 40 stores the determination result into the storage part of the control part 40.

<<Inspection of Closing Operation of Fourth Valve>>

Steps S36 to S39 in FIG. 8 are the same control processing as that at steps S16 to S19 in FIG. 7 of the first embodiment.

At step S36, the control part 40 transmits an instruction of performing the opening operation to the seventh valve 13 and transmits an instruction of performing the closing operation to the fourth valve 31. At step S37, on the basis of the detection result received from the flowmeter 22, the control part 40 determines whether or not the flow rate of the air is less than or equal to a threshold. Similarly to steps S23, S26, S29, and S33, the threshold at this step S37 is 0.1 [liter/min].

At step S37, if it is determined that the flow rate of the air is greater than the threshold (NO), the control part 40 advances the control processing to step S38. At step S38, the control part 40 determines that the closing operation of the fourth valve 31 is abnormal. The control part 40 stores the determination result into the storage part of the control part 40 or alternatively notifies it through a given information part. After that, the control part 40 terminates the control processing.

On the other hand, at step S37, if it is determined that the flow rate of the air is less than or equal to the threshold (YES), the control part 40 advances the control processing to step S39. At step S39, the control part 40 determines that the opening and closing operation of the fourth valve 31 is normal. The control part 40 stores the determination result into the storage part of the control part 40. After that, the control part 40 terminates the control processing.

<Operation Effect>

In the fuel cell system 1 of the present embodiment, abnormality in the second valve 14 is allowed to be inspected by using the oxidation gas. By virtue of this, even when the closing operation of the second valve 14 has abnormality, a possibility that hydrogen is discharged to the outside in association with the implementation of inspection is allowed to be reduced. Further, according to the control processing for valve inspection according to the first and the second embodiment, the opening and closing operation of the plurality of valves including the second valve 14 along the fuel gas passage member 10 is allowed to be inspected. In particular, according to the control processing for valve inspection according to the first embodiment, abnormality in the closing operation of the second valve 14 which is remarkably important is allowed to be detected rapidly. Thus, the fuel cell system 1 with improved safety is allowed to be provided.

<Modifications>

In the embodiments given above, the flowmeter 22 is arranged in the oxidation gas passage member 20 at a position located between the air pump 21 and the substitution passage member 30. However, the flowmeter 22 may be arranged at any position as long as the air flowing through the inspection route is allowed to be detected at that position. For example, the flowmeter 22 may be arranged in the oxidation gas passage member 20 between the air pump 21 and the second position P2. The flowmeter 22 may be arranged in the substitution passage member 30. The flowmeter 22 may be arranged in the fuel gas passage member 10 on a side opposite to the first valve 12 with respect to the first position P1. That is, it is sufficient that the flowmeter 22 is arranged at any position in the inspection route.

In the present embodiment, the flowmeter 22 has been employed as an example of the detection part detecting the flow of air. However, in place of the flowmeter, a sensor detecting the flow velocity and the pressure of air may be employed. For example, the flow velocity of air may be detected by employing a sensor having a configuration similar to that of the flowmeter 22. Whether the detection result of the sensor is to be treated as a flow rate or as a flow velocity may be selected suitably. For example, the pressure of air may be detected by employing a diaphragm pressure sensor or the like.

The present disclosure has been described above with reference to the embodiments. However, it is not an overemphasis to say that the present disclosure is not limited to the embodiments given above and may be applied in a state of being suitably changed within an extent of not deviating from the spirit.

It is to be noted that, as used herein and in the appended claims, the singular forms “a”, “an”, and “the” include plural referents unless the context clearly dictates otherwise.

What is claimed is:

1. A fuel cell system in which fuel gas and oxidation gas are supplied respectively to an anode electrode and a cathode electrode of a membrane/electrode assembly so that electricity is generated, comprising:
a stack in which a plurality of the membrane/electrode assemblies and a plurality of separators are stacked together;
a fuel gas passage member in which the stack is arranged midway and a fuel gas supply source is connected to one end;
an oxidation gas passage member in which the stack is arranged midway;
an oxidation gas supply source connected to one end of the oxidation gas passage member;
a substitution passage member which connects a first position located in the fuel gas passage member between the stack and the fuel gas supply source, and a second position located in the oxidation gas passage member between the stack and the oxidation gas supply source;
a first valve arranged in the fuel gas passage member between the first position and the fuel gas supply source and allowed to switch between an open state and a closed state;
a second valve arranged in the fuel gas passage member on a side opposite to the first valve with respect to the stack and allowed to switch between an open state and a closed state;
a third valve arranged in the oxidation gas passage member on a side opposite to the oxidation gas supply source with respect to the stack and allowed to switch between an open state and a closed state;
a fourth valve arranged in the substitution passage member and allowed to switch between an open state and a closed state;
a detection part arranged in any one of the oxidation gas passage member between the oxidation gas supply source and the second position, the substitution passage member, and the fuel gas passage member on a side opposite to the first valve with respect to the first position, and then detecting flow of the oxidation gas; and
a control part performing at least the following controls a) to d) at any timing,
a) a control of transmitting to the first valve and the third valve an instruction of performing closing operation of switching from the open state to the closed state,
b) a control of transmitting to the fourth valve an instruction of performing opening operation of switching from the closed state to the open state,
c) a control of transmitting to the oxidation gas supply source an instruction of supplying the oxidation gas, and
d) a control of, on the basis of a detection result of the detection part, determining whether the opening operation or the closing operation of the second valve is normal or abnormal.

2. The fuel cell system according to claim 1, wherein the control part executes the following controls e) and f),
e) a control of, in the control a), further transmitting to the fourth valve and the second valve an instruction of performing the closing operation, and
f) a control of determining that the closing operation of any of the first valve, the third valve, the fourth valve, and the second valve is abnormal in the case where the detection result of the detection part is greater than a threshold after performance of the control e) and the control c).

3. The fuel cell system according to claim 2, wherein the control part executes the following controls g) and h),
g) a control of transmitting to the fourth valve an instruction of performing the opening operation of the control b), in the case where the detection result of the detection is less than or equal to the threshold after performance of the control e) and the control c), and
h) a control of determining that the closing operation of the second valve is abnormal in the case where the detection result of the detection part after the control g) is greater than the threshold.

4. The fuel cell system according to claim 3, wherein the control part executes the following controls i) and j),
i) a control of transmitting to the second valve an instruction of performing the opening operation in the case where the detection result of the detection part after the control g) is less than or equal to the threshold, and
j) a control of determining that the opening operation of the fourth valve or the second valve is abnormal in the case where the detection result of the detection part after performing the control i) is less than or equal to the threshold.

5. The fuel cell system according to claim 4, wherein the control part executes the following controls k) and l),
k) a control of transmitting to the fourth valve an instruction of performing the closing operation in the case where the detection result of the detection part after the control i) is greater than the threshold, and
l) a control of determining that the closing operation of the fourth valve is abnormal in the case where the detection result of the detection part after the control k) is greater than the threshold.

6. The fuel cell system according to claim 2, wherein the control part executes the following controls m) and n),
m) a control of transmitting to the fourth valve an instruction of performing the opening operation of the control b) and transmitting to the second valve an instruction of performing the opening operation, in the case where the detection result of the detection part is less than or equal to the threshold after performance of the control e) and the control c), and
n) a control of determining that the opening operation of the fourth valve or the second valve is abnormal in the case where the detection result of the detection part after the control m) is less than or equal to the threshold.

7. The fuel cell system according to claim 6, wherein the control part executes the following controls o) and p),
o) a control of transmitting to the second valve an instruction of performing the closing operation in the case where the detection result of the detection part after the control m) is greater than the threshold, and
p) a control of determining that the closing operation of the second valve is abnormal in the case where the detection result of the detection part after the control o) is greater than the threshold.

8. The fuel cell system according to claim 7, wherein the control part executes the following controls q) and r),
q) a control of transmitting to the second valve an instruction of performing the opening operation and transmitting to the fourth valve an instruction of performing the closing operation in the case where the detection result of the detection part after the control o) is less than or equal to the threshold, and
r) a control of determining that the closing operation of the fourth valve is abnormal n the case where the detection result of the detection part after the control q) is greater than the threshold.

9. The fuel cell system according to claim 1, comprising a fifth valve arranged in the substitution passage member and constructed such as to be allowed to shut off a fluid flow from the fuel gas passage member to the oxidation gas passage member and allowed to permit a fluid flow from the oxidation gas passage member to the fuel gas passage member.

10. The fuel cell system according to claim 2, comprising a fifth valve arranged in the substitution passage member and constructed such as to be allowed to shut off a fluid flow from the fuel gas passage member to the oxidation gas passage member and allowed to permit a fluid flow from the oxidation gas passage member to the fuel gas passage member.

11. The fuel cell system according to claim 3, comprising a fifth valve arranged in the substitution passage member and constructed such as to be allowed to shut off a fluid flow from the fuel gas passage member to the oxidation gas passage member and allowed to permit a fluid flow from the oxidation gas passage member to the fuel gas passage member.

12. The fuel cell system according to claim 1, comprising a sixth valve arranged in the oxidation gas passage member at a position located between the second position and the stack and constructed such as to be allowed to shut off a fluid flow from the stack to the second position and allowed to permit a fluid flow from the second position to the stack.

13. The fuel cell system according to claim 2, comprising a sixth valve arranged in the oxidation gas passage member at a position located between the second position and the stack and constructed such as to be allowed to shut off a fluid flow from the stack to the second position and allowed to permit a fluid flow from the second position to the stack.

14. The fuel cell system according to claim 3, comprising a sixth valve arranged in the oxidation gas passage member at a position located between the second position and the stack and constructed such as to be allowed to shut off a fluid flow from the stack to the second position and allowed to permit a fluid flow from the second position to the stack.

15. The fuel cell system according to claim 1, comprising a seventh valve arranged in the fuel gas passage member at a position located between the first position and the stack.

16. The fuel cell system according to claim 2, comprising a seventh valve arranged in the fuel gas passage member at a position located between the first position and the stack.

17. The fuel cell system according to claim 3, comprising a seventh valve arranged in the fuel gas passage member at a position located between the first position and the stack.

18. A fuel cell system in which fuel gas and oxidation gas are supplied respectively to an anode electrode and a cathode electrode of a membrane/electrode assembly so that electricity is generated, comprising:
a stack in which a plurality of the membrane/electrode assemblies and a plurality of separators are stacked together;
a fuel gas passage member in which the stack is arranged midway and a fuel gas supply source is connected to one end;
an oxidation gas passage member in which the stack is arranged midway;
an oxidation gas supply source connected to one end of the oxidation gas passage member;
a substitution passage member which connects a first position located in the fuel gas passage member between the stack and the fuel gas supply source, and a second position located in the oxidation gas passage member between the stack and the oxidation gas supply source;
a first valve arranged in the fuel gas passage member between the first position and the fuel gas supply source, allowed to switch between an open state and a closed state, and remaining in the closed state in an initial state;
a second valve arranged in the fuel gas passage member on a side opposite to the first valve with respect to the stack, allowed to switch between an open state and a closed state, and remaining in the closed state in an initial state;
a third valve arranged in the oxidation gas passage member on a side opposite to the oxidation gas supply source with respect to the stack, allowed to switch between an open state and a closed state, and remaining in the closed state in an initial state;
a fourth valve arranged in the substitution passage member, allowed to switch between an open state and a closed state, and remaining in the closed state in an initial state;
a detection part arranged in any one of the oxidation gas passage member between the oxidation gas supply source and the second position, the substitution passage member, and the fuel gas passage member on a side opposite to the first valve with respect to the first position, and then detecting flow of the oxidation gas; and
a control part which transmits to the fourth valve an instruction of performing opening operation of switching from the closed state to the open state, and determines whether the opening operation or the closing operation of the second valve is normal or abnormal based on the flow of the oxidation gas detected by the detection part when the oxidation gas is supplied and a threshold.

19. A control method executed in a fuel cell system including:
a stack in which a plurality of membrane/electrode assemblies and a plurality of separators are stacked together;
a fuel gas passage member in which the stack is arranged midway and a fuel gas supply source is connected to one end;
an oxidation gas passage member in which the stack is arranged midway;
an oxidation gas supply source connected to one end of the oxidation gas passage member;
a substitution passage member which connects a first position located in the fuel gas passage member between the stack and the fuel gas supply source, and a second position located in the oxidation gas passage member between the stack and the oxidation gas supply source;
a first valve arranged in the fuel gas passage member between the first position and the fuel gas supply source and allowed to switch between an open state and a closed state;
a second valve arranged in the fuel gas passage member on a side opposite to the first valve with respect to the stack and allowed to switch between an open state and a closed state;
a third valve arranged in the oxidation gas passage member on a side opposite to the oxidation gas supply source with respect to the stack and allowed to switch between an open state and a closed state;
a fourth valve arranged in the substitution passage member and allowed to switch between an open state and a closed state; and
a detection part arranged in any one of the oxidation gas passage member between the oxidation gas supply source and the second position, the substitution passage member, and the fuel gas passage member on a side opposite to the first valve with respect to the first position, and then detecting flow of the oxidation gas, wherein
the method comprises:
transmitting to the first valve and the third valve an instruction of performing closing operation of switching from the open state to the closed state;
transmitting to the fourth valve an instruction of performing opening operation of switching from the closed state to the open state; and
determining whether the opening operation or the closing operation of the second valve is normal or abnormal based on the flow of the oxidation gas detected by the detection part when the oxidation gas is supplied and a threshold.

20. The control method executed in a fuel cell system according to claim 19, wherein the method comprises:
transmitting to the second valve and the fourth valve an instruction of performing closing operation of switching from the open state to the closed state when transmitting to the first valve and the third valve an instruction of performing closing operation of switching from the open state to the closed state; and
determining whether or not the closing operation of any of the second valve, the third valve, and the fourth valve is abnormal based on the flow of the oxidation gas detected by the detection part when the oxidation gas is supplied and a threshold.
